(19) United States
(12) Patent Application Publication
(10) Pub. No.: US 2014/0374327 A1
(43) Pub. Date: Dec. 25, 2014

(54) METHOD AND APPARATUS FOR POINT OF USE WATER FILTRATION

(71) Applicant: The Water Initiative, LLC, Norwalk, CT (US)

(72) Inventors: Thomas A. Langdo, Cambridge, MA (US); Eugene A. Fitzgerald, Windham, NH (US); Richard Renjilian, Gumee, IL (US); Larry R. Brown, Newton, MA (US)

(21) Appl. No.: 14/365,502

(22) PCT Filed: Dec. 14, 2012
(86) PCT No.: PCT/US2012/069852

§ 371 Date: Jun. 13, 2014

Related U.S. Application Data
(60) Provisional application No. 61/576,219, filed on Dec. 15, 2011.

(51) Int. Cl. C02F 1/00; C02F 1/28

(52) U.S. Cl. CPC C02F 1/00; C02F 1/28
USPC 210/85; 210/323.1; 210/335

(57) ABSTRACT

An apparatus for water filtration includes a base a filtration receptacle coupled to the base and a carafe removably coupled to the base. The filtration receptacle includes a water inlet and a water outlet. The filtration receptacle includes a pleated filter positioned between the water inlet and the water outlet. The pleated filter has a pleat face characterized by a surface having a plurality of peaks and a plurality of valleys, such that the surface is disposed in a plurality of planes. The filtration receptacle is structurally configured to maintain the pleated filter in an orientation wherein the pleat face of the pleated filter transverses a water-flow path extending from the water inlet to the water outlet. The filtration receptacle is further configured to induce water-flow along the water-flow path by at least one of a receptacle orientation and a receptacle geometry. The carafe includes an inlet coupled to the water outlet in the filtration receptacle.

### CROSS REFERENCE TO RELATED APPLICATIONS

The present application claims priority to U.S. Provisional Application No. 61/576,219, filed Dec. 15, 2011, entitled “METHOD AND APPARATUS FOR POINT OF USE WATER FILTRATION,” which application is incorporated herein by reference in its entirety.

### BACKGROUND

Regional organizations, such as municipal water distribution facilities, heavily emphasize water purification actions occurring prior to distribution of the water to a region or local community. Notwithstanding the complicated and costly endeavors implemented to sanitize water in such manners, water supplies may still contain or acquire contaminants following central processing by a municipal or other regional water facility as the water is distributed from the facility to end-users at their homes and offices.

Existing point of use water purification systems available to end-users incorporate a number of inefficient and ineffective components. The cost and inefficiencies associated with current systems, some of which include filtered pitchers, faucet attachments, and units built into water distributing refrigerators, result, in part, from the crude methods used to determine when a filter is exhausted. Such systems may account for only the length of time that a system has been in use, which may result in a false positive or false negative indication of the filter status.

The false indicators associated with these systems may cause an end-user to dispose of a filter prematurely or continue using a filter well-passed its capacity for effective filtration. Furthermore, existing systems lack the ability to efficiently and cost effectively remove certain minerals and pathogens to provide high quality water choices.

### SUMMARY

The inventors have appreciated that water may be efficiently and effectively filtered through an inventive point of use water filtration apparatus. The inventors have further appreciated that such a device may efficiently implement a variety of inventive supplementation techniques to provide high-quality water in a variety of forms.

In view of the foregoing, the present disclosure is directed to methods and apparatuses for water filtration.

In some exemplary inventive embodiments disclosed herein, a water filtration apparatus includes a base, a filtration receptacle coupled to the base, and a carafe removably coupled to the base. The filtration receptacle has a water inlet and a water outlet. The filtration receptacle includes a pleated filter positioned therein. The filter is disposed between the water inlet and the water outlet and the pleated filter includes a pleat face characterized by a surface having a plurality of peaks and a plurality of valleys, such that the surface is disposed in a plurality of planes. The filtration receptacle is structurally configured to maintain the pleated filter in an orientation wherein the pleat face of the pleated filter transverses a water-flow path extending from the water inlet to the water outlet. The filtration receptacle is further configured to induce water-flow along the water-flow path by at least one of a receptacle orientation and receptacle geometry. The carafe is coupled to the base such that a carafe inlet is coupled to the water outlet in the filtration receptacle.

In some embodiments, the carafe may include a carafe outlet. The carafe outlet may be positioned in a bottom region of the carafe. The carafe outlet may also include a valve. The valve may be configured to open when the carafe is coupled to the base and to close when the carafe is removed from the base. The base may include a port in fluid communication with the carafe coupled to the base via the opened valve in the carafe outlet. The apparatus may also include a pump coupled to the base. The pump may be coupled to the port in the base. The apparatus may include a plurality of pumps coupled to the base.

In some embodiments, the carafe is configured as a serving pitcher having at least a handle and a spout. In some embodiments, the apparatus may include a supplementation receptacle coupled to the base. The supplementation receptacle is configured for holding a supplementary substance. The supplementation receptacle includes a supplementation receptacle entry port coupled to the pump. The supplementation receptacle includes a fluid path coupled to a single serve outlet port disposed above a single serve holder region coupled to the base. The supplementation receptacle may include a fluid path selectively coupled to at least one of the single serve outlet port and the carafe inlet for selectively filtering and supplementing a single or bulk serving of a water based beverage. A single serving generally describe a serving that is smaller than a bulk serving. However, a neither a single serving nor a bulk serving are limited to any particular size. For example, a single serving may include a 2, 4, 6, 8, 10, 12, 16, 20, 24, fluid oz servings, or a 1 liter serving. A single serve outlet port is distinguished from a bulk serving outlet port based on the destination of the filtered and/or supplemented water. More particularly the single serving outlet port directs water to a region configured for holding a container generally configured for consumption by an individual while the port for delivering a bulk serving directs water to a region configured for holding a container generally configured for consumption by multiple individuals or a single individual over a plurality of servings, which in various embodiments is typically a carafe. The supplementation receptacle may include a disposable supplementation cartridge. The supplementation cartridge includes a cartridge seal coupled to a cartridge housing and has a supplementary substance disposed therein. The supplementation cartridge may have a geometric shape corresponding to the supplementation receptacle. The supplementation cartridge may have an interior partitioned into a filtration region and a supplementation compartment. The supplementary substance in the supplementation cartridge may include at least one of a flavor component, vitamins, a salt extractor, minerals, herbal extracts, and pharmaceuticals. The supplementary substance may be a liquid, a solid. The solid may be granulated or powdered. As noted, the supplementation cartridge may, in addition to including substances for addition to filtered water, may include substances for supplementary filtering of water. As such, the supplementation cartridge may provide a secondary filter stage. As such, commercial implementations of inventive embodiments may provide a filtration apparatus provided with a primary filter functional within the filtration receptacle and may allow users to obtain a supplementation cartridge based on a perceived need at a water supply that provide specific types of secondary filtration levels as an alternative to or in addition to injecting flavor or other substances into the water for consumption. These secondary filtration processes maybe be performed to remove contaminants for health or water aesthetic reasons to improve the flavor or consistency of the supplementation process. For example, a user may obtain a filtration apparatus with a primary filter configured to filter out common contaminants and if the user is made aware that their water source contains irregularly high levels of radium, the user may obtain supplementation cartridges for supplemental filtration in a manner similar to selecting a flavor the user desires. Similarly, it is well known that water mineral content affects the taste and appeal of water and beverages. In this case the user may obtain a filtration apparatus with a primary filter configured to filter out water components such as salts, total dissolved solids (TDS), minerals, water hardness, or other similar components which can affect the flavor of the beverage or supplementation process. Such removal could be achieved through the use of ion exchange processes through the use of ion exchange resins or zeolites to reduce or eliminate the mineral content of water for improved supplementation consistency and elimination of undesirable tastes.

In various inventive embodiments, the filtration apparatus may include a supplementation receptacle coupled to the base and configured to hold a supplementary substance. The supplementation receptacle may include an entry port in fluid communication with the water outlet in the filtration receptacle, the supplementation receptacle having a fluid path selectively coupled to a single serve outlet port disposed above a single serve holder region coupled to the base.

In some embodiments the filtration apparatus may include a supplementation receptacle coupled to the base. The supplementation receptacle may be configured for holding a supplementary substance therein and may further include a time release or controlled release substance to allow multi-serve use. The filtration apparatus may also include an indicator configured to provide a signal indicating a status of the supplementary substance related to multi-serve use.

In some embodiments, the water filtration apparatus includes a temperature modulation unit including a heating unit, a cooling unit, and a controller.

In some embodiments, the water filtration apparatus includes an erosion based filter status indicator. The indicator may be positioned between the water inlet and the water outlet. The indicator provides a signal indicating a status of the filter. The signal is provided after a pre-determined amount of flow dependent erosion has occurred to the indicator. The erosion based filter may include an erodible polymer.

In some embodiments, the filtration apparatus is less than 16³ cubic inches.

Other exemplary embodiments include methods of filtering water in a water filtration apparatus. The methods according to such embodiments introduce water into a filtration receptacle coupled to a base of the water filtration apparatus. The filtration receptacle includes a water inlet and a water outlet. The filtration receptacle includes a pleated filter. The pleated filter is disposed between the water inlet and the water outlet. The pleated filter has a pleat face characterized by a surface having a plurality of peaks and a plurality of valleys, such that the surface is disposed in a plurality of planes. The method further includes causing the water to flow along a water flow path extending from the water inlet to the water outlet, such that the water traverses the pleat face of the pleated filter.

In another exemplary embodiment, a water filtration apparatus includes a base, a filtration receptacle coupled to the base, and an erosion based filter status indicator. The filtration receptacle includes a water inlet and a water outlet. The filtration receptacle has a filter positioned therein. The filter is disposed between the water inlet and the water outlet. The indicator is positioned between the water inlet and the water outlet. The indicator provides a signal indicating a status of the filter after a predetermined amount of flow dependent erosion has occurred to the indicator. The signal may be electronic. The signal may be one or more of a visual indicator, an audible indicator, and a taste indicator. The visual indicator may be configured to change the color of the water. The visual indicator may be a word.

Another exemplary embodiment provides a method of filtering water in a water filtration apparatus. The method includes introducing water into a water filtration receptacle coupled to a base of the water filtration apparatus. The filtration receptacle has a water inlet and a water outlet and includes a filter positioned between the water inlet and the water outlet. The filtration receptacle further includes an erosion based filter status indicator. The indicator is positioned between the water inlet and the water outlet and provides a signal indicating a status of the filter. The signal is provided after a predetermined amount of flow dependent erosion has occurred to the indicator. The method further includes causing the water to flow along a water flow path extending from the water inlet to the water outlet, such that the water traverses the filter and the indicator and such that the indicator is eroded. The method also includes indicating, via a signal, the status of the filter after a predetermined amount of flow dependent erosion has occurred to the indicator.

Another exemplary embodiment provides a disposable water filtration cartridge for use with a water filtration apparatus. The cartridge includes a cartridge seal coupled to a cartridge housing. The cartridge housing has a geometric shape corresponding to a cartridge receptacle of the water filtration apparatus. The cartridge housing has an interior partitioned into a filtration region and a supplementation compartment. The filtration region includes a filtration substance. The supplementation compartment includes a supplementary substance. The filtration region is partitioned from the supplementation region such that liquids entering the filtration region traverse the filtration substance and subsequently enter the supplementation region and traverse the filtration substance before exiting the cartridge.

In some embodiments, the filtration region and the supplementation region of the disposable water filtration cartridge may be disposed in a stacked orientation. The stacked orientation may be fixed in some embodiments and may be user configurable in other embodiments. The cartridge housing may include a solid partition wall having an opening positioned adjacent to a peripheral wall of the cartridge housing. The opening provides a fluid pathway between the filtration region and the supplementation region. In other embodiments the filtration and supplementation regions are separated by a water permeable membrane, mesh, woven, paper, or similar material with water flowing substantially through the area of this separating layer.

In some embodiments, the filtration region and the supplementation region of the disposable water filtration cartridge may be disposed in a lateral orientation. The cartridge housing may include a solid partition wall having an opening positioned at the top and periphery of both the filtration region and the supplementation region. The opening provides a fluid pathway between the filtration region and the supplementation region. In other embodiments the filtration and supplementation regions are separated by a water permeable membrane, mesh, woven, paper, or similar material with water flowing substantially through the area of this separating layer.

In another embodiment, the filtration region and supplementation region of the disposable water filtration cartridge are disposed in a stacked orientation where the filtration substance partitions the filtration region from the supplementation region.

Another inventive embodiment provides a method of filtering water that includes piercing a disposable cartridge. The disposable cartridge has a cartridge seal and a cartridge housing with an interior partitioned into a filtration region and a supplementation region. The filtration region includes a filtration substance and the supplementation region includes a supplementary substance. The method further includes introducing water into the disposable cartridge. The water is introduced into the filtration region and is subsequently introduced into the supplementation region, such that the water traverses the filtration substance before entering the supplementation region. The method further includes causing the water to exit the supplementation region and the cartridge housing.

The method may include causing the water to exit the cartridge housing by piercing the cartridge housing and the supplementation region. In some embodiments, the shape of the filtration substance corresponds to a cross-section of the cartridge housing.

Another exemplary inventive embodiment provides a water filtration apparatus including a base, a filtration receptacle coupled to the base, a carafe removably coupled to the base and a supplementation receptacle coupled to the base. The filtration receptacle has a water inlet and a water outlet and a filter positioned between the water inlet and the water outlet. The carafe includes an inlet coupled to the water outlet in the filtration receptacle. The supplementation receptacle is configured for holding a supplementary substance therein. The supplementation receptacle includes a supplementation receptacle entry port in fluid communication with the water outlet in the filtration receptacle. The supplementation receptacle has a fluid path selectively coupled to a single serve outlet port and a carafe entry port in the carafe. The outlet port is disposed above a single serve holder region, whereby the filtration apparatus is operable to selectively filter and supplement a water based beverage for a single serving or a bulk serving.

In another embodiment, a water filtration apparatus is provided that includes a base, a filtration receptacle coupled to the base, and carafe removably coupled to the base. The filtration receptacle has a water inlet and a water outlet. The filter includes a plurality of removable filter modules selected from the following group: a disinfection module, a taste improvement module, an organic contaminant removal module, an arsenic removal module, a base pathogen module, a mineral removal module, a salt removal module, a flavor module, a vitamin module, a pharmaceutical module. The carafe is coupled to the base such that a carafe inlet is coupled to the water outlet in the filtration receptacle.

Exemplary inventive embodiments also provide a computer program product. The computer program product includes computer readable code stored on a tangible storage medium. The computer readable code forms a computer program executable by a computer for filtering water with a water filtration apparatus. The computer program includes computer code for causing water to flow into a water filtration receptacle coupled to a base of the water filtration apparatus. The filtration receptacle includes a water inlet and a water outlet having a filter positioner there between. The filter further includes an erosion based filter status indicator. The computer program further includes computer code for causing the filtered water to enter a supplementation receptacle. The supplementation receptacle is configured for holding a supplementary substance therein. The supplementation receptacle further includes a supplementation receptacle entry port coupled to the pump. The supplementation receptacle has a fluid path coupled to a single serve outlet port disposed above a single serve holder region coupled to the base.

In another embodiment, a water filtration apparatus is provided that includes a base, a filtration receptacle coupled to the base, and a carafe removably coupled to the base. The filtration receptacle includes a water inlet and a water outlet. The filtration receptacle includes a filtration media positioned therein. The filtration media includes at least one of metal oxide and metal hydroxide. The filtration media is disposed between the water inlet and the water outlet. The filtration receptacle is structurally configured to maintain the filtration media in an orientation wherein the filtration media transverses a water-flow path extending from the water inlet to the water outlet. The filtration receptacle is further configured to induce water-flow along the water-flow path by at least one of a receptacle orientation and a receptacle geometry. The carafe is removably coupled to the base such that a carafe inlet is coupled to the water outlet in the filtration receptacle.

In another embodiment, a water filtration apparatus is provided that includes a carafe and a filtration receptacle coupled to the carafe. The filtration receptacle includes a water inlet and a water outlet. The filtration receptacle includes a filter disposed between the water inlet and the water outlet. The filter includes a plurality of removable filtration modules selected from the group consisting of a disinfection module, a taste improvement module, an organic contaminant removal module, an arsenic removal module, a base pathogen module, a mineral removal module, a salt removal module, a flavor module, a vitamin module, and a pharmaceutical module. The filtration modules are stackable in a user specified order within the filtration receptacle, such that an interior region in the carafe is coupled to the water outlet in the filtration receptacle. In some embodiments the disinfection module, the organic contaminant removal module, the arsenic removal module, the base pathogen removal module, the mineral removal module, and the salt removal modules are permeable to at least one flavor from the flavor module, at least one vitamin from the vitamin module, and at least one pharmaceutical from the pharmaceutical module, whereby the at least one flavor, vitamin and pharmaceutical are not substantially reduced when water passes through the filter and are maintained in the water at substantially the same quantity level after water passes through the entire filter as when introduced by the flavor, vitamin, and pharmaceutical module. In some embodiments, the modules may be stacked such that the flavor, vitamin and pharmaceutical modules are positioned down stream of the filtration module whereby water passing through the filtration module permeates one or more of the disinfection module, the organic contaminant removal module, the arsenic removal module, the base pathogen removal module, the mineral removal module, and the salt removal module before permeating one or more of the flavor, vitamin and pharmaceutical modules.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein, that also may appear in any disclosure incorporated by reference, should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 provides a schematic illustration of an apparatus for water filtration, in accordance with one inventive embodiment.

FIG. 2 is a schematic of a filtration schemes in accordance with various inventive embodiments.

FIG. 3 shows a temporal progression of a filtration status indicator in accordance with an inventive embodiment.

FIGS. 4-6 illustrate disposable cartridges for combined filtration and supplementation in accordance with various inventive embodiments.

FIG. 7 provides a schematic illustration of an apparatus for water filtration, in accordance with another inventive embodiment.

FIG. 8 depicts a multistage filtration module, in accordance with various inventive embodiments.

The features and advantages of the inventive embodiments will become more apparent from the detailed description set forth below when taken in conjunction with the drawings.

### DETAILED DESCRIPTION

Following below are more detailed descriptions of various concepts related to, and embodiments of, inventive systems, methods and apparatus for improving water quality through filtration and effective supplementation techniques. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Various inventive embodiments disclosed herein are directed generally to apparatuses and methods for water filtration. The inventive embodiments described herein demonstrate a point of use water filtration apparatus that can effectively and efficiently remove water impurities, control the temperature of the water or beverage to the consumer's preference, and add beneficial or desirable molecules to the water for consumption.

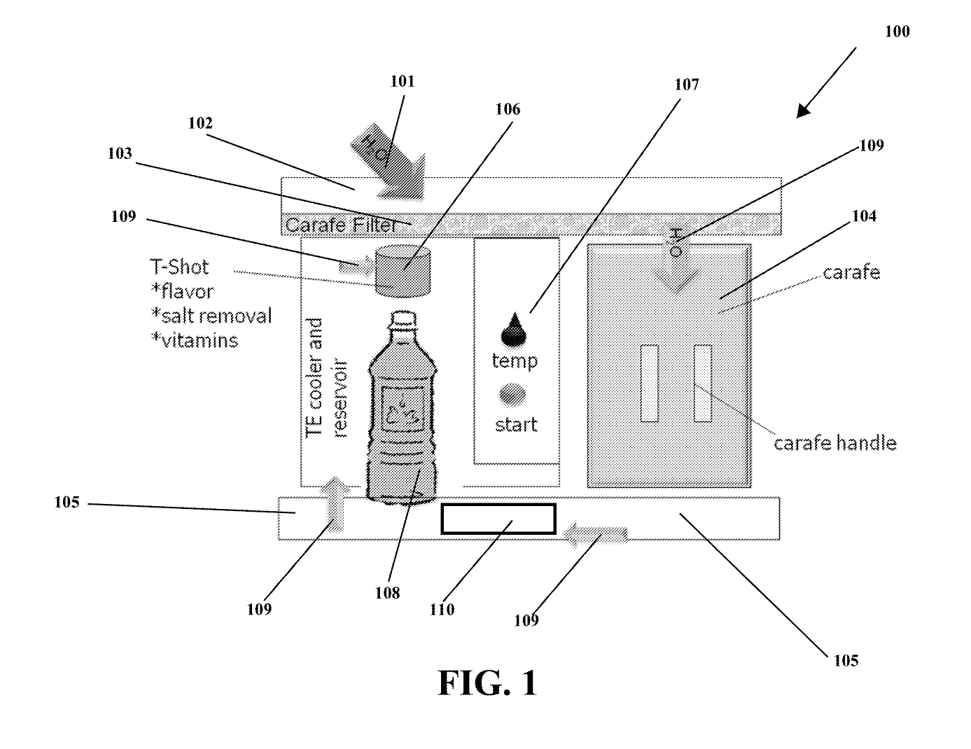

FIG. 1 provides a schematic illustration of an apparatus for water filtration, in accordance with one inventive embodiment. The schematic demonstrates generally the flow of operations that are engaged in an appliance provided according to various inventive embodiments. Because such an apparatus may generally be designated for point of use (POU) operations in a home or office setting, the apparatus may be provided in a geometrical form that is less than 16³ cubic inches.

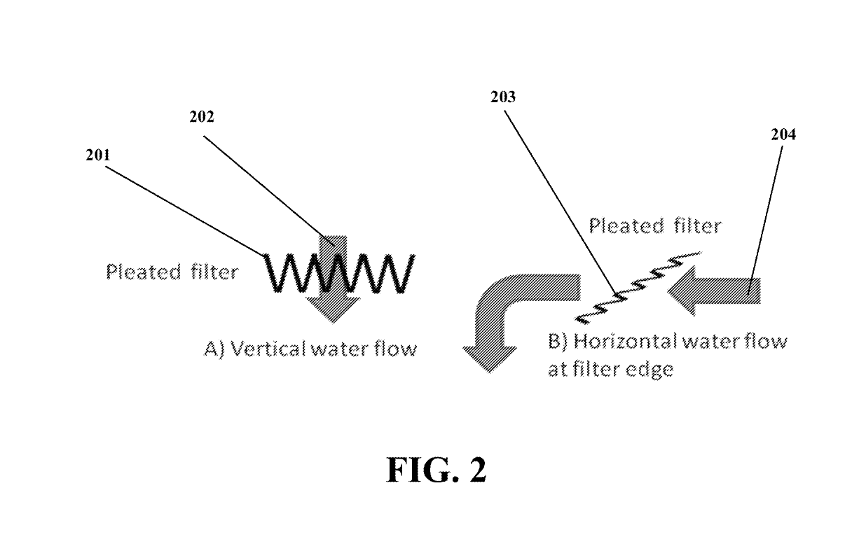

As demonstrated in FIG. 1, water 101 may initially be introduced into appliance 100 for filtration. This entry may occur in an upper region of appliance 101 and may introduce water 101 directly into a filtration receptacle. Filtration receptacle 102 may include a removable or pivoting lid, or other opening mechanism to allow a user to introduce water therein. The filtration receptacle 102 houses a replaceable filter 103, which may include a pleated filter, as discussed further herein in connection with FIG. 2. In accordance with various inventive embodiments, the water may be introduced using removably coupled carafe 104 or the water 101 may be fed into filtration receptacle via a water line (not shown) coupled, directly or indirectly, to filtration receptacle 102. A connection to a dedicated water line, similar to the scheme employed for a refrigerator ice maker or water dispenser may be provided. By way of example, the water line may be connected directly to the base 105 and may be pumped up through a channel, tube, or other coupling component to filtration receptacle 102. In such an exemplary inventive embodiment, a pump 110 may be provided to pump the water, or backpressure from the water supply may sufficiently achieve an acceptable pumping flow-rate.

Receptacle 102 may be geometrically shaped or oriented to cause the water introduced therein to flow in a particular manner and to a particular location, in accordance with various inventive embodiments. By way of non-limiting example, receptacle 102 may be angled to cause water introduced therein to flow towards an outlet in the receptacle. Alternatively or additionally, receptacle 102 may have a base or channels therein that are shaped to cause water introduced into the receptacle to flow from the point of entry to an outlet or exit port in the receptacle. Receptacle 102 may also be provided with other features such as fasteners, tabs, or partitions to direct the flow in a particular manner, or pathway and to maintain the filter 103 positioned therein in a particular orientation with respect to the induced flow. Such mechanisms may include a plurality of levels provided within the receptacle and may cause the water to flow from those levels towards certain portions or regions of the filter. The geometric configuration of receptacle 102 may also be tailored to direct water introduced into the receptacle away from the edges of the receptacle and away from the edges of the filter disposed therein. For example, the receptacle may have a bowed configuration including one or more levels. As discussed further herein in accordance with various inventive embodiments, filter 103 may provide a multistage filtration cartridge. As disclosed further herein, filter 103 may include a pleated filter in some inventive embodiments, but may include a non-pleated filter in other inventive embodiments.

After introduction into the filtration receptacle and after traversing the filter disposed therein, the water may then be permitted to enter the removable serving pitcher carafe reservoir 104. The carafe may be disposed in various locations on the base 105 of the filtration appliance 100. A valve may be provided at the filtration receptacle outlet. The valve may be configured to permit filtered water 109 to flow only when carafe 104 is coupled to the appliance. Pitcher carafe 104 provides a reservoir for the water at various stages, in accordance with inventive embodiments, and may also function as serving pitcher for a dinner table or for storage, for example within a refrigerator. In accordance with various embodiments disclosed herein, carafe 104 may provide a reservoir for water before and/or after the water is processed beyond an initial filtration. Carafe 104 may also function as a reservoir during cooling and or heating of filtered water. In an exemplary embodiment, pump 110 may be used to cause water to flow from pitcher carafe 104 to a smaller cooling or heating reservoir. Pump 110 may include any kind of pump for creating achieving a desired flow rate and water pressure. A second pump may push the water from the smaller cooling or heating reservoir to a supplementation receptacle 106 having components for altering or supplementing the purified water. Supplementation receptacle 106 may be sized to accommodate a single serve supplementing cartridge or a multi-serve supplementing cartridge. Said cartridge, cup, or pod functions to infuse one or more of flavor, vitamins, minerals, herbal or plant extracts, and pharmaceuticals. Once the beverage is infused with the user specified supplements the water based beverage may be dispersed into a single serve container 108 such as a cup, mug, bottle glass, etc.

As further demonstrated, appliance 100 may include a control panel through which an end user can choose a variety of beverage setting including, but not limited too, quantity, concentration or strength, and temperature.

The water filtration technology used in inventive embodiments is compatible with a ‘point-of-use’ (POU) water purification approach. POU systems are composed of components that remove water impurities on a relatively small scale, e.g., a table-top or home-oriented system as opposed to a large central facility, like a municipal water treatment facility. Different technologies may be used to remove dissolved minerals and compounds compared to pathogen or microbial control.

In accordance with various inventive embodiments, adsorption technology may be used to remove dissolved minerals and compounds such as arsenic, fluoride, and lead which may be present in the user's water. Adsorption technology has advantages, which include its near 100% water yield (no water rejection), automatic operation, operation under gravity flow, and ability to effectively remove the contaminants present. In various exemplary embodiments, the adsorption material may include at least one of activated carbon, a metal oxide, or a metal hydroxide, whereby the filtration cartridge is operable to filter water in a temperature range of 5 C (Celsius) to 40 C.

Maximizing the life of adsorption media requires proper choice of adsorption media, flow conditions, and filter design. In addition to efficacy, two large concerns for users are throughput (flow rate) and lifetime. An important parameter for increasing filtration media lifetime and flow rate is the flow per unit area, or hydraulic loading rate, with lower hydraulic loading rates being advantageous for media lifetime. This advocates making individual filtration stages thus filters short and fat (for example with an aspect ratio less than 1).

Exemplary inventive embodiments provide large diameter vessels to allow low hydraulic loading rates, while achieving reasonable flow rates. Typical media parameters for hydraulic loading from vendors are 8 gpm/ft². Laboratory testing of arsenic and fluoride medias revealed that filtration media lifetimes may be dramatically extended by operating filters at much lower hydraulic loadings, for example, below 4 gpm/ft², and below 2.5 gpm/ft². Low hydraulic loading rates allow the adsorption media to work more efficiently to store contaminants by allowing time for intrapore diffusion and more efficient saturation of adsorption sites.

Exemplary inventive embodiments incorporating low hydraulic loading such as at or below 4 gpm/ft², may be implemented with filtration media including metal oxide and hydroxide medias and rare earth materials, such as granular ferric hydroxide, activated alumina, granular ferric oxide, titanium oxide, zirconium oxide, cerium oxide, hafnium oxide, lanthanum oxide or another metal oxide or mixtures. Other potential filtration materials include activated carbons, zeolites, and ion exchange resins. In various embodiments, the filtration material including at least one of zeolites and ion exchange resins provide a filtration cartridge operable to filter water in a temperature range of 5 C to 99 C. Ion exchange resins may be weak acid cation resins, weak base anion resins, or a mixture of anion and cation resins to remove mineral content. Demineralization applications typically utilize a mixed bed of strong base and strong acid ion exchange resins. All of these media materials may be included in distinct layers, or may be mixed. Accordingly, inventive embodiments include filter stages with aspect ratios less than one.

To address pathogens or microbial contamination generally requires different approaches. Water with inadequate or nonexistent disinfection capabilities (such as chlorine disinfection) may be contaminated with pathogens. This may occur due to inadequate chlorination infrastructure or because of a disruption of the central treatment disinfection process after a natural disaster or supply pipe rupture. The POU system provided according to various inventive embodiments disclosed herein possess disinfection capabilities, which may be implemented using one or more membranes, active disinfecting through controlled release of disinfection compounds, and/or a combination of the two.

As provided above various inventive embodiments disclosed herein provide multifaceted functionality, while conserving precious countertop space, through the use of a stylish serving pitcher carafe 104, which also serves as a filtered water reservoir. This pitcher serving reservoir is generally present in the appliance 100 after the water filtration stage, but before any cooling or supplementing mechanisms. In accordance with some embodiments, carafe 104 locks into the system with a leak proof bottom connection. In addition, there may be time release additives released into the pitcher or reservoir by time release devices present either in the pitcher or after the previous filtration step to impart desirable or beneficial molecules such as vitamins, minerals, or extracts, in accordance with various inventive embodiments.

Pitcher 104 may include a valve disposed within the bottom of the pitcher to prevent water leakage when pitcher 104 is removed from appliance 100 for serving. The pitcher may also include a mechanism to make sure that it is properly aligned upon insertion into the appliance. As part of that alignment verification, pitcher 104 may clip into the base with aligned cam action, which requires a slight rotation of pitcher 104 to lock according to inventive embodiments. There may also be a level sensor in the pitcher, which may rely on a floatation activated sensor, with the level read system operating by magnetic (such as a reed switch), mechanical, or optical or photo sensing component. Pitcher 104 may have to interlock to verify that it is loaded into appliance 100, for example by means of an infrared (IR) sensor or similar device.

Water in the water pitcher serving reservoir may typically be at ambient room temperature, although the pitcher may be removed and chilled in a kitchen refrigerator if desired. The volume of this reservoir is large enough to provide adequate water, but not too large to be cumbersome and heavy. It may range between 1.5 to 4 liters of water, and in some embodiments may be between 2 to 3 liters of water.

Water in the pitcher 104 is typically at ambient room temperature as noted above, but may be adjusted to the user's preference by the use of additional cooling and heating components. The water temperature may be adjusted using a pump and small thermally insulated, thermally adjusted reservoir prior to dispensing through the molecule supplementation system. A separate cooling reservoir may be smaller than the main removable pitcher serving reservoir, in the range of 0.5 L volume. For cooling, a conventional refrigerator compressor or solid state thermoelectric cooling module may be implemented. For heating, a standard resistive heating element may be used. Thermoelectric coolers operate as heat pumps utilizing the Peltier effect in conjunction with a heat sink and fan on the ambient (hot) side which draws heat away from the water reservoir and results in cooling. Thermoelectrics offer the potential to adjust the temperature to the user preference through a “dial a temperature” approach, which dial may be provided via control panel 107. Thermal pumping of the thermoelectric can be controlled by adjusting current to the thermoelectric module or the speed of the cooling fan or both. It may also be reversed to pump heat from the hot side (ambient) to the cool side (water) to warm the water. This allows adjustment of the temperature from chilled water to warm water slightly above ambient room temperature of the unit by the user by an appropriate control system. This temperature control allows the user another level of water and beverage customization to preference.

FIG. 2 is a schematic of a filtration schemes in accordance with various inventive embodiments. As demonstrated in FIG. 2, a filter 201 disposed within a filtration receptacle may be provided in a pleated filter arrangement, in accordance with various inventive embodiments. Filter 201 may be provided in a square or rectangular shape and may correspond to a peripheral shape of a filtration receptacle or may have an alternative shape that extends to the perimeter of the filtration receptacle. In various embodiments filter 201, may have a square or rectangular filter inscribed inside a circle to combine a pleated filter with a circular filter arrangement.

A membrane mechanically filters out pathogens in a water filtration system provided in various embodiments. This type of filtration typically requires the use of a membrane with pore sizes comparable and preferentially smaller than the pathogen. To mechanically remove protozoan cysts requires membranes with pore sizes on the order of 1 micron, while bacteria removal typically requires pore sizes on the order of 0.1 micron. The flow of water through a membrane with 0.1 micron pore size is very slow, typically on the order of milliliter per min per cm² of membrane area. This is typically too slow to filter a reasonable amount of water through gravitationally induced flow. This area limitation is overcome in inventive embodiments by increasing the surface area available for filtration by pleating.

Pleating may be implemented in different embodiments disclosed herein. In one approach, a rectangular or square filter shape may be used to allow pleating and thus, increase the filter area and flow through the large rectangular area. Using pleating, it is possible to increase filter area by a factor of 10 if 1 inch deep pleats and 5 pleats per inch are used. This larger increase in area allows the practical introduction of small pore size filters such as 0.1 micron filters in a POU application employing substantially vertical gravity fed water flow 202.

In other embodiments, the water flow may be configured for lateral flow, as demonstrated by reference 204, along the perimeter of vertically oriented pleated filter 203. Filter 203 allows pleating of the membrane along a subset of the filter height close to the perimeter. This lateral approach, which takes advantage of the perimeter, is amenable to a range of filter shapes including, but not limited to, circular and rectangular shapes. The membranes used may include any of the standard membranes available from Millipore, Pacific Membranes, Pall, or specially membranes such as the Ahlstrom Disruptor or 3M Virasorb material.

In another approach, disinfection compounds which are beneficial to the user can be added through controlled, time release methods to actively disinfect the water, performing a benefit to the user. The POU filter system of the invention has either or a combination of both approaches. Some embodiment disclosed herein implement time release methods to actively disinfect the water and kill all types of pathogens from viruses to bacteria in manners that provide various advantageous over membrane only approaches. A time release implementation may be combined with the aforementioned membrane implementations and offers a multi-tiered defense for microorganisms to eliminate cysts, which are resistant to chlorination. In addition to the aforementioned disinfection implementations, inventive embodiments provided herein may incorporate other disinfection aspects, such as photocatalytic deactivation, UV treatment, or ozonation.

Filtration systems according to inventive embodiments disclosed herein have different stages, which target different contaminants for increased efficiency and performance. The filter according to such embodiments may be designed to exhibit high flows, above 0.5 liters per minute, while maintaining low hydraulic loading rates below 2.5 GPM/ft². Thus, the filter area in such embodiments is generally greater than 0.05 ft² and may be square or round. In some embodiments, the filter may be at least half as wide as the serving pitcher reservoir. In such embodiments, the filter geometry may be decoupled from constraints imposed by the geometry of the serving pitcher. Thus, the filter may be larger (wider) than the pitcher to take advantage of favorable filtration parameters.

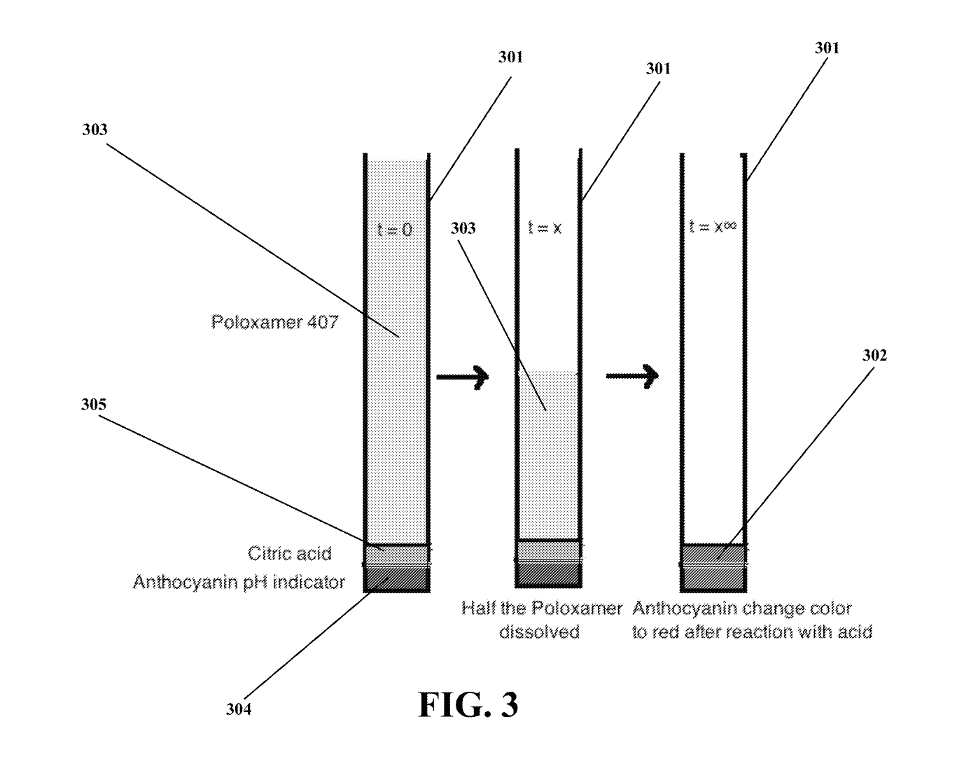

FIG. 3 shows a temporal progression of a filtration status indicator implementing notification and sensing technology according to inventive embodiments. It is advantageous to have a simple, robust, low cost sensor technology to alert the user when the filter can be changed. Various inventive embodiments provided herein account for the amount or volume of water used in the filtration system to notify a user of the appropriate time to change the filter. Some of these inventive embodiments implement the use of polymers and chemicals to provide such a notification. In these embodiments, the polymers and chemicals used are food ingestion grade components. In some embodiments, a filter change indicator may include a water quality parameter including at least one of water temperature, water TDS (total dissolved solids), pH level, and mineral content of the water.

In one approach, a water mediated reaction alerts the user to change the filter through a color change. Water reaches the chemical reaction area of an indicator 301 either by slow dissolution of a water-soluble polymer 303 in controlled layer-by-layer erosion, or by diffusion through a membrane at a controlled rate. This water penetration by erosion or diffusion is proportional to the number of water treatments and will serve as the basis for measuring of filter water throughput, and thus lifetime. The following example is for an approach utilizing polymer erosion, but an analogous example can be created for the diffusion case. Once the polymer coating 303 is eroded by repeated water exposure, a vegetable derived food grade pH indicator 304 will react with a small quantity of food grade acid 305 to yield a change in color. Other chemical reactions could be substituted, but for illustrative purposes we demonstrate the use of a pH change and resulting color indication using an eroding polymer 303. The water soluble eroding polymer 303 (which erosion is demonstrated as the decreasing level of the polymer from time 0 (t=0) to time x (t=x) to some time following (t=x∞)), may be chosen from one of following list of example polymers available as food grade polymers: Polyvinyl pyrrolidone, Poloxmer 407 (triblock copolymer of polypropylene oxide and polyethylene oxide), Dextran, Polyvinyl alcohol, cellulose, PLGA (poly lactic glycolic acid). Anthocyanin is an example food grade colorant that chemically reacts to change color upon dissolution and mixing as the pH indicator. Anthocyanin is derived from various vegetables such as red cabbage (See http://www.food-info.net/uk/colour/anthocyanin.htm). The cabbage occurs in a very large group of red-blue plant pigments. Anthocyanins occur in all higher plants, mostly in flowers and fruits but also in leaves, stems, and roots. The color of anthocyanins depends on the structure, but also on the acidity of the fruit. Many anthocyanins are red at acidic conditions and turn blue at less acid conditions. Anthocyanins are used as food additive with E number E163 (E163 Anthocyan(in)s). This pH change additive may be placed in one reservoir separated from a food grade acid in powder form such as phosphoric acid or citric acid.

A timing sensor structure may be created with a layer of the anthocyanin food grade pigment 304 at the bottom in accordance with various inventive embodiments. The anthocyanin is covered by a layer of water soluble polymer such as Poloxamer 407. Then a second chamber having a layer of food grade acid 305, such as citric acid in powder form, is provided. This structure may be covered with a thin water permeable membrane. This membrane simply separates the two reaction areas in close proximity and restrains them from moving. That structure may then be covered with a second Poloxamer 407 layer 303, which is the eroded polymer layer that serves as the timing layer. Upon water exposure the soluble Poloxamer 407 will dissolve layer by layer with each exposure to water to perform the timing function. After a designed number of water exposures, the citric acid will dissolve. Soon after the dissolution of the citric acid 305, the thin Poloxamer 407 layer beneath it will hydrate and expose the anthocyanin 304 to the citric acid 305. A color change 302 occurs, changing from blue to red indicating “x” uses of the water treatment device. The diagram of proposed device shown below, with the water soluble polymer being present in the y axis. The structure may be incorporated such that the window showing the color change is visible after final Poloxamer 407 completely dissolves. Sensor 303 may be incorporated into the treatment unit of filtration receptacle somewhere between the inlet on the receptacle and the outlet, such that each filling of the treatment unit with water exposes the sensor to the associated volume of water.

In other inventive embodiments, an opaque water soluble polymer or food coating may be used to cover a printed message on a woven fiber, paper, teabag, or similar material. The printed message may be used as a visual indicator for notifying the user to change the filter by exposing a message that says “change filter”. The polymer coating erodes at a known rate, and thus, by choice of polymer and the thickness thereof, a user filter notification device is provided with a known notification time related to the volume of water based erosion. The water soluble eroding polymer may be chosen in such an embodiment from the same list provided above, namely: Polyvinyl pyrrolidone, Poloxamer 407 (triblock copolymer of polypropylene oxide and polyethylene oxide), Dextran, Polyvinyl alcohol, Celluslose, PLGA (poly lactic glycolic acid). The polymers may be made opaque, in accordance with inventive embodiments, by inclusion of a second phase such as an opaque pigment or dye such as food grade titanium dioxide with E number E171, which covers the printed message. By proper design of the coating layer, this opaque water soluble coating erodes at a known rate upon water exposure. After a predetermined water exposure, the opaque coating erodes, and the message is revealed informing the user to change the filter.

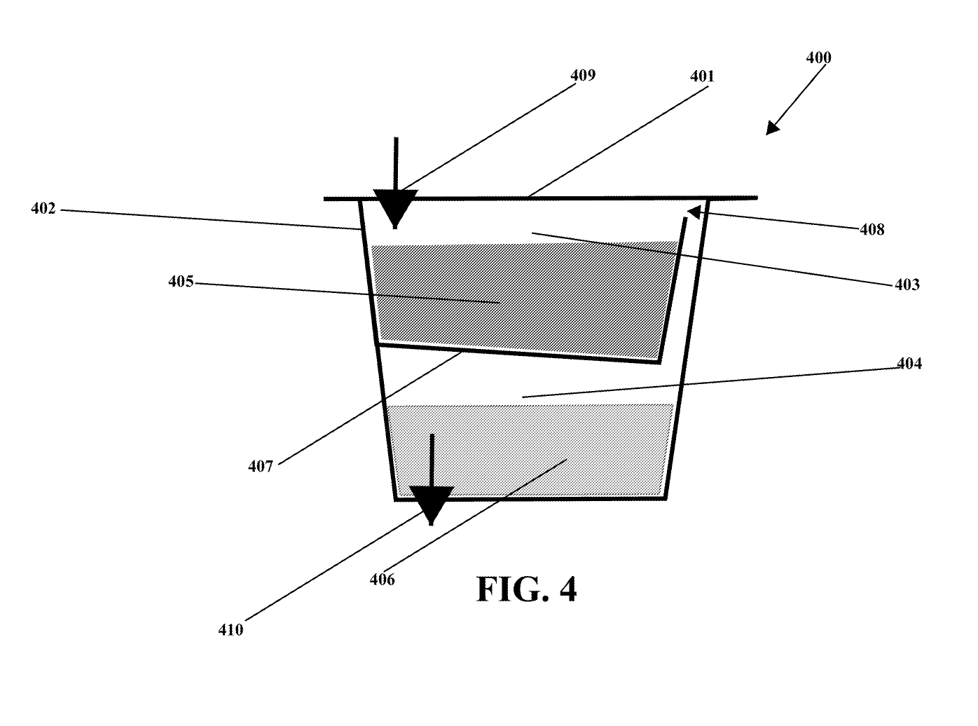

FIGS. 4-6 illustrate disposable cartridges for combined filtration and supplementation in accordance with various inventive embodiments. The disposable cartridges provided by such embodiments may be used in a water filtration system without a separate filtration system or in combination with a separate filtration system. In such embodiments, a cartridge 400 may be provided in a cup or pod form, and may include a sealing layer 401, sealing an opening in housing 402 used for filing the cartridge. The cartridge housing 402 may having a geometric shape corresponding to a cartridge receptacle of an associated water filtration apparatus. The interior of cartridge housing 402 may be partitioned into a filtration region or compartment 403 and a supplementation region or compartment 404. The filtration compartment 403 includes a filtration substance 405. The supplementation compartment 404 includes a supplementary substance 406. In accordance with various inventive embodiments, the filtration region is partitioned from the supplementation region such that liquids entering the filtration region traverse the filtration substance and subsequently enters the supplementation region traverses the filtration substance before exiting the cartridge. In some embodiments, filtration cartridge 400 may include a visual indicator operable to provide a signal indicating a status of the supplementary substance 406.

FIG. 4 illustrates a cartridge 400, wherein the filtration region 403 and the supplementation region 404 are disposed in a stacked orientation. In this embodiment, cartridge housing 402 includes a solid partition wall 407 having an opening 408 positioned adjacent to a peripheral wall of the cartridge housing. Opening 408 provides a fluid pathway between the filtration region 403 and the supplementation region 404. Opening 408 is disposed a distance away from an entry port 409, which may be generated by a cannula of the filtration device such that liquids entering the filtration region 403 traverse the filtration substance 405 and before entering the supplementation region 404, traversing the supplementation substance 406, and exiting the filtration compartment 403 via exit 410, which also may be generated by a cannula of the filtration device. The cartridge housing may include a positioning tab or slot (not shown) so that the cannulas for generating ports 409 and 410 are properly oriented with respect to opening 408. Seal 401 and housing 402 may be provided of a suitable material penetrable by the filtration device such that ports 409 and 410 remain sealed until implementation of the filtration device for preparation of a beverage. The filtration substance 405 may include any of the filtration media disclosed herein and the supplementation substances 406 may include any of the supplementing substances disclosed herein for adding vitamins, tastes, extracts, minerals, or pharmaceuticals. For example, filtration substance 405 may be a single or mixed bed ion exchange resin to substantially remove salt, ions, or minerals from the water. The flow rate of liquid into cartridge 400 may be provided such that adequate filtration interaction is achieved.

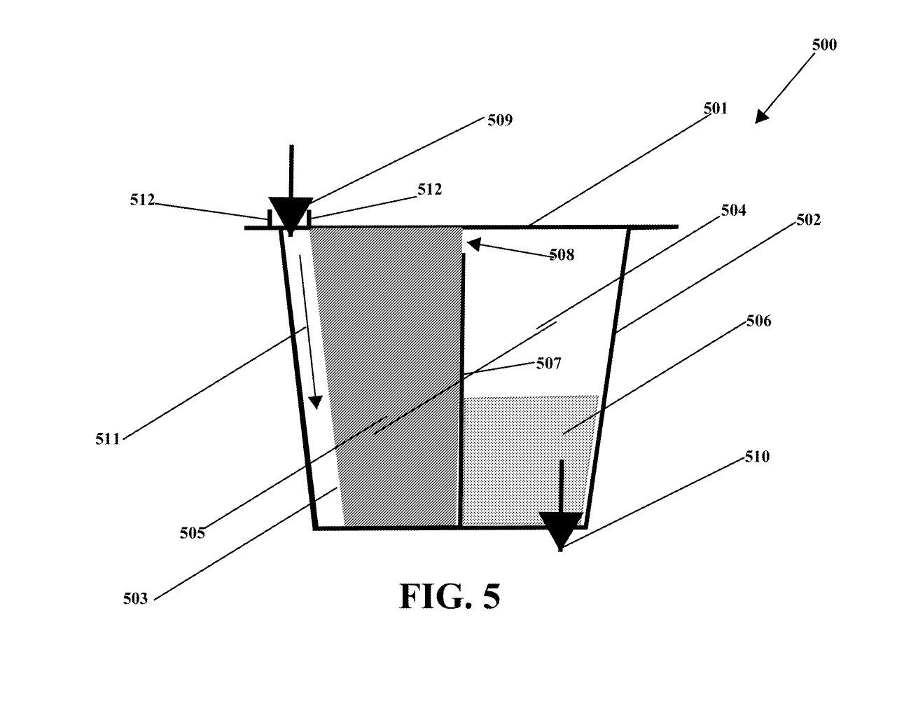

FIG. 5 illustrates a cartridge 500, wherein the filtration region 503 and the supplementation region 506 are disposed in a lateral orientation with respect to one another and the cartridge housing 502 includes a solid partition wall 507 having an opening 508 positioned at the top and periphery of both the filtration region 503 and the supplementation region 506, the opening 508 provides a fluid pathway between filtration region 503 and the supplementation region 506. Seal 501 and housing 502 may be provided of a suitable material penetrable by the a filtration device and such that ports 509 and 510 remain sealed until created by implementation of the filtration device for preparation of a beverage. The cartridge housing may include positioning tabs or slot 512 so that the cannulas for generating ports 509 and 510 are properly oriented with respect to opening 508 and the filtration substance 505. The filtration substance 505 may include any of the filtration media disclosed herein and the supplementation substances 506 may include any of the supplementing substances disclosed herein for adding vitamins, tastes, extracts, minerals, or pharmaceuticals. For example, filtration substance 505 may be a single or mixed bed ion exchange resin to substantially remove salt, ions, or minerals from the water. In some embodiments, substance 505 may be disposed with cartridge 500 such that a pathway 511 for fluid entering cartridge 500 through port 509 travels to the bottom of compartment 503 and travel up through substance 506 before traversing opening 508. Additionally, ports 509 and 510 may be disposed on opposite sides of the housing in laterally disposed configuration to ensure complete infusion and filtration. The flow rate of liquid into cartridge 500 may be provided such that adequate filtration interaction is achieved.

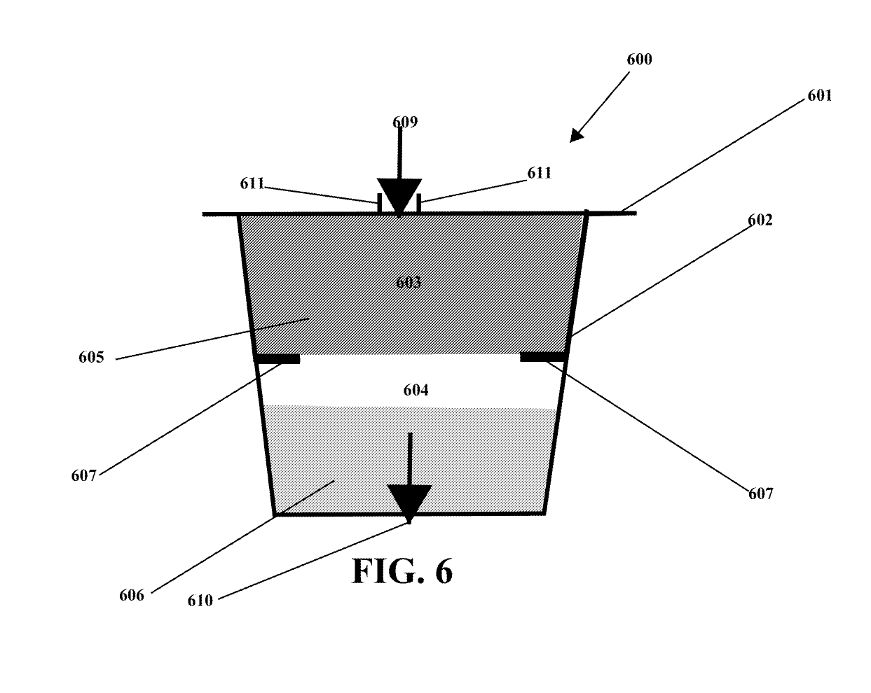

FIG. 6 illustrates a cartridge 600, wherein the filtration region 603 and the supplementation region 604 are disposed in a stacked orientation. In this embodiment, cartridge housing 602 is sealed by seal 601. Filtration region 603 includes a filtration substance 605, which serves as the primary partition between region 603 and 604. Supplementation region 604 includes a supplementation substance 606 therein. The filtration substance 605 may include any of the filtration media disclosed herein and the supplementation substances 606 may include any of the supplementing substances disclosed herein for adding vitamins, tastes, extracts, minerals, or pharmaceuticals. For example, filtration substance 605 may be a single or mixed bed ion exchange resin to substantially remove salt, ions, or minerals from the water. Seal 601 and housing 602 may be provided of a suitable material penetrable by the a filtration device and such that ports 609 and 610 remain sealed until created by implementation of the filtration device for preparation of a beverage. The cartridge housing may include positioning tabs or slot 611 so that the cannulas for generating ports 609 and 610 are properly oriented with respect to filtration substance 605. Filtration cartridge 600 may also include tabs 607 for supporting substance 605 and maintaining it in the proper orientation to prevent liquids entering region 603 through port 609 from entering region 604 without traversing filtration substance 605. The flow rate of liquid into cartridge 600 may be provided such that adequate filtration interaction is achieved.

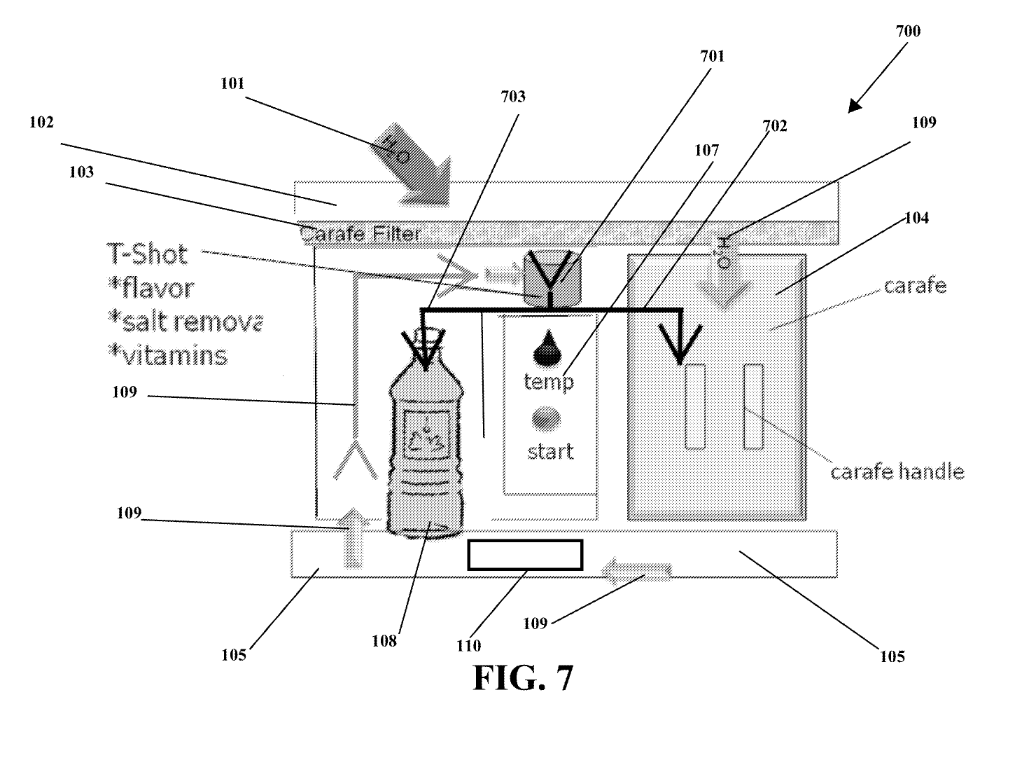

FIG. 7 provides a schematic illustration of an apparatus for water filtration, in accordance with another inventive embodiment. Inventive embodiments disclosed herein provide a cup or pod type system for single serve or multi serve applications with both being achievable in both filtration and supplementation forms. The supplementation cups termed “Tcups” may contain one or more of vitamins, tastes, extracts, minerals, or pharmaceuticals to be added to the purified water to create a nutritious beverage. For example, the dispensing of pharmaceuticals in a beverage may be advantageous for some individuals to allow them to take pharmaceuticals in cases where they have an aversion or difficulty swallowing pills, or for drinking a prescribed amount of water with their medication, etc. As demonstrated in FIG. 4, once filtered water 109 emerges it may be rooted through the system to arrive at supplementation receptacle 701. Receptacle 701 allows a user to selectively use a Tcup supplementation cartridge to infuse a single serve beverage, which will initiate a flow 703 to a single serve container 108 or to infuse a bulk serve beverage, which will initiate a flow 701 to carafe 104. Receptacle 701 may include one or more valves operable to select the appropriate flow path and timing for the desired level of concentration. Furthermore, receptacle 701 may be sized to accommodate both single serve and bulk or multi-serve Tcup cartridges.

The Tcups provided according to such inventive embodiments may be hermetically sealed capsules to preserve the chemical nature of the interior contents. The contents may be in the form of a syrup, in some embodiments, to decrease the amount of time required for complete dissolution and mixing. In other embodiments, powders or timed release formations may be used. In some embodiments, more than one form (for example a syrup and a powder may be implemented in stages. In the case of timed release approaches, the Tcup may be implemented for a multi-serve application rather than single serve cup.

The Tcup may be loaded into a mechanical jaw type assembly to be punctured by separate hollow needles or cannulas to introduce water for formation of the beverage and for draining of the resulting beverage. These needles may be on opposite sides of the Tcup as demonstrated in connection with FIGS. 4-6, (top and bottom) or they may be on the same side (both on the Top, both on the bottom, both on the sides). To promote mixing, the water introduction needle may have the water outlet be at an angle to the need point, ranging from 10 to 90 degrees. This angled water injection would create a swirling motion inside the Tcup to promote mixing and beverage homogeneity. In addition, the Tcup may also have additional structures present to promote mixing. One type could be a mixing bar or propeller type component which would turn with water inject to promote mixing. Or the Tcup may have a spiral wall type pattern inside, with the water introduction occurring in the Tcup at the edge, and the water draining out of the center. The cartridge housing may include positioning tabs or slots, such as those previously illustrated, so that the needles or cannula for generating entry and exit ports are properly oriented with the interior mechanisms for optimum operation. To make puncturing of the Tcup as repeatable as possible, it would be advantageous to have the needles puncture the same material. This could be accomplished by fabricating the top and bottom surfaces by foil, held together with a polymer frame, or by puncturing only the foil surface with both needles. In the case of puncturing a single foil surface with both needles, it would be advantageous to have the Tcup inserted foil side down so that it makes drainage of the resulting beverage easier.

The use of timed release is another approach that allows the creation of a multi-serve Tcup product. In the case of a timed release material, the system would be configured for a predetermined number of multiple uses for a given Tcup. The system may determine and automatically adjust the number of Tcup lifetime by information on the Tcup. The system may be the form of a barcode, RFID tag, mechanical cut out for optical or mechanical detection, or a raised mechanical bump or pattern of bumps which could be read, etc. After the predetermined number of uses, the machine may lock out the system and prompt the user to change the Tcup.

This timed release material may be configured several different ways. It may be an insoluble polymer host matrix with target compound(s) to be delivered. It may be a reservoir system with a membrane through which diffusion occurs of the target compound(s). Or it may be a dissolvable carbohydrate, fat, wax, or confectionary matrix which contains the target compound and is released as the matrix is dissolved.

In various embodiments, the time release Tcup contains the beneficial release compound(s) (vitamins, minerals, pharmaceuticals, etc) in a water insoluble polymer matrix, such that the release compound(s) are homogeneously distributed throughout the matrix. The polymer matrix may be in the form of a sheet, tablet, pellet, or hemisphere located inside the Tcup. For example, similar pellets fabricated by this approach show excellent release of disinfection compounds, and are referenced in the following international patent publication WO2010/096521.

In general, the polymer may be chosen from ethylene vinyl acetate, low or high density polyethylene, polypropylene, polystyrene, or silicone among others. The polymers utilized include food contact grade polymers. The fabrication parameters of the polymer such as molding temperature are chosen to prevent substantial degradation of the beneficial compound.

In a preferred embodiment, the polymer is ethylene vinyl acetate. The controlled release of the beneficial compound is tailored through choice of the compound to be released, the polymer, the release compound to polymer ratio, the particle size of the release compound, and the method of manufacture which controls the homogeneity of the resulting matrix. The polymer matrix may be more than 1% release source by weight, but less than 90% release source by weight. The result may be provided in a tablet, capsule, hemisphere or sheet which releases the beneficial compound controllably into the beverage system. The use of the matrix geometry and any barrier coating is important to control the release rate.

In another embodiment, the beneficial compound is encapsulated by a polymer coating and released by diffusion through the bulk of the coating or shell. Alternatively, the beneficial compound may be embedded in a slow dissolving non-polymer matrix to allow consistent release over time due to the fixed solubility of the host material. This slow release matrix or coating may be a wax, carbohydrate, cellulose, or hydrogel. The barrier coating process mentioned above could be used for any matrix approaches which are diffusion limited, both insoluble polymer ones as well as soluble carbohydrate, etc. approaches.

Inventive embodiments provided herein include TCups designed to remove or substitute selected or broad range minerals from the water in addition to being able add beneficial or desirable molecules in a single serve or limited serving space. For example, in some applications it may be desirable to remove all the salt or total dissolved solids (TDS) content from water due to personal preference or high TDS levels present in the starting water. Typically TDS is reduced in water filtration systems using ion exchange resins but this approach suffers from a limited capacity due to the large amount of TDS present in normal waters (typically greater than 200 mg/L). Embodiments disclosed herein accommodate the capacity limitation encountered when using ion exchange resigns through implementation of Tcups with such resins disposed therein. For example, a 1.5″ diameter, 1″ tall TCup may be filled with a commercial demineralizing ion exchange resin for removal TDS from the water, offering a unique water customization option. Such resins are available from Dow (MR-3) or other vendors. The volume of ion exchange resin in such a small volume could completely demineralize more than 4 liters of water with 250 mg/L TDS, or 1 liter with 1000 mg/L TDS, reducing the level below 20 mg/L. The system may include a TDS meter upstream of the demineralizing Tcup which calculates for the user and adjusts lifetime accordingly so that the user would know when to change the Tcup and is able to use it multiple servings. This calculation may be generalized by measuring some parameter of the water and electronically adjusting the Tcup lifetime for the user based on a calculation. In addition to demineralization, the Tcups may be used in a simple ion exchange capacity, for example to swap sodium with calcium for those whose medical condition requires limiting sodium or who have water supplies with high sodium content.

In another embodiment, this ion exchange or demineralizing step can be integrated into a single capsule or TCup containing a supplementation component. In this approach the water would pass through the ion exchange portion of the TCup and have reduced mineral content prior to entering the supplementation region. In contrast to adsorption materials such as metal oxides or activated carbons, ion exchange materials are capable of functioning at substantially elevated temperatures. Thus, ion exchange materials can be effectively used to remove salts, ions and minerals at elevated temperatures used in the preparation of hot beverages. Ion exchange materials are typically polymer based ion exchange resins or clay zeolites. For ion exchange resins, the maximum ion exchange operating temperature varies by resin but typically ranges between 60 C to approximately 150 C. These are much higher than the typical temperature limits of adsorption materials which are limited to water temperatures of 40 C or less. Thus unlike adsorption materials, ion exchange materials are well suited to the filtration of hot water prior to making coffee, tea, cocoa, and other hot beverages. The elimination of salts, ions, and minerals would help to improve beverage consistency since these water parameters vary greatly from region to region and have a large impact on taste.

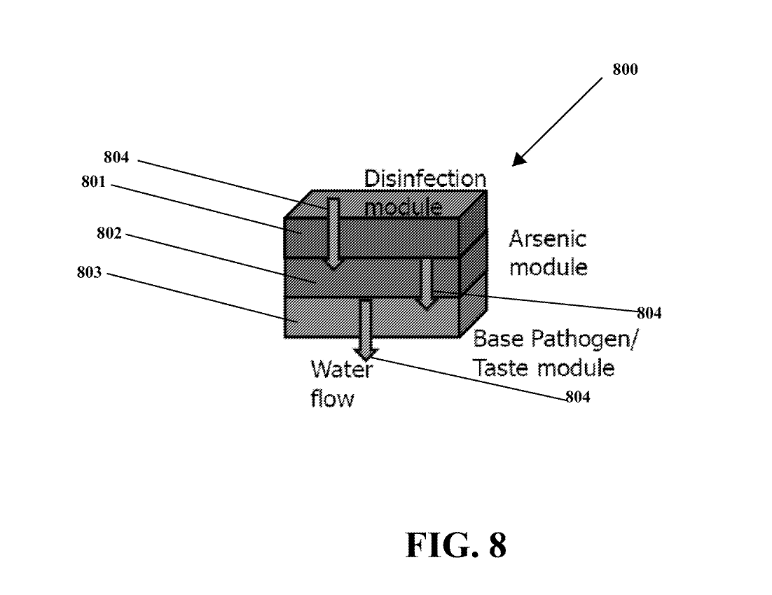

FIG. 8 depicts a multistage filtration module in accordance with various inventive embodiments. Embodiments of the present invention may include a plurality of levels of filtration through the use of modular, multistage filtration cartridges. Such cartridges may be implemented to have a disinfection module 801, an arsenic removal module 802, and pathogen removal module 803. As water flows through multistage filtration cartridge 800, each stage is traversed by water 804 before exiting the filtration cartridge. The cartridge may include a housing and each of the modules may be removably disposed within the housing. Status indicators may be provided for each module so that they are individually replaceable upon exhaustion of each. The exemplary filtration stages, which may be provided in a variety of multi-stage configurations, are provided as follows. FIG. 8 illustrates a square multistage filtration cartridge, however, the cartridge may be implemented in other geometries, for example circular geometries.

The disinfection stage implemented by module 801 provides active disinfection. In some embodiments, the disinfection is achieved through release of disinfection compounds (typically halogen based) through controlled, time release methods to actively disinfect the water, performing a benefit to the user. This stage may be provided as an initial stage in various inventive embodiments to allow the halogen time to interact and kill pathogens. Additional membrane protection may be employed in subsequent stages, for example, at the end of the filtration system to perform maximum benefit to the user and minimize the chances of recontamination. In some embodiments, active carbon may be provided as a substitute for the disinfection module.

In various embodiments, a targeted mineral removal module 802 may be implemented for arsenic or fluoride. Module 802 may incorporate metal oxide medias, such as iron modified activated alumina (Alcan AAFS50) for fluoride removal. Arsenic may be removed by a number of metal oxide medias based on activated alumina (Alcan AAFS50 or 400G), ceria, iron oxide (Severn Trent GFO media), iron hydroxide (Siemens GFH media), or titania (Dow Adsorbia media, Graver Metsorb media, Siemens ASG media).

In some inventive embodiments, targeted heavy metal removal for lead, mercury, cadmium may be implemented. Removal of these heavy metal substances may be achieved through the use of a targeted ion exchange material such as ATS sorbent offered by Surfatas, or titania (Dow Adsorbia media, Graver Metsorb media) or ion exchange resins that are single bed or mixed bed.

In some embodiments, activated carbon may be utilized for removal of organic compounds, chlorine, and objectionable tastes and odors. Organic compounds may be man made industrial solvents or halogenated chlorine disinfection by products or naturally occurring organic compounds such as geosmin or 2-Methylisoborneol (MIB). This activated carbon stage assists with the removal of disinfection compounds that may be intentionally introduced into water, for example by a municipal water treatment facility, and any byproducts of prior stages.

In various inventive embodiments, a pathogen contamination protection stage may be provided in module 803. Such a stage may incorporate use of membranes or materials with biocidal properties. Membrane approaches may be used to increase the flow rate to appreciable levels for small pore sizes envisioned, on the order of 0.2 to 1.2 micron for bacteria and cyst removal. Membranes from hydrophilic materials such as Nylon, Polysulfone (PS), or Polyethersulfone (PES) may be used to achieve higher flows. Viruses may be eliminated in such embodiments by the use of membranes such as Ahlstrom's Disruptor Membrane, or 3M's Virasorb. This stage may use a nested set of membranes to prevent fouling with a small pore size membrane such as 0.2 micron protected by 1.2 micron membrane, in accordance with various inventive embodiments. The membranes in this stage may also filter out non microbial contaminants, which frequently occur as precipitates such as lead. Instead of membranes contact disinfectants materials which have biocidal activity through halogen groups covalently bonded to the surface (e.g., materials available from Halosource) or materials which exhibit antimicrobial properties such as copper or ceria could be used.

In some embodiments, the final stage of the multistage cartridge may include a supplementation component for introducing beneficial molecules such as vitamins through a constant release mechanism as described in further detail later. This constant release mechanism may be built into the filter assembly as the final stage, or may be separately located after the filter assembly but before the serving pitcher such that water in the serving pitcher has the beneficial molecule(s) added. The beneficial molecules introduced may interfere with and be removed by the filtration media. Thus, it may be advantageous in some embodiments to allow the beneficial compounds to be released into the water without uptake by the filter. This is achievable by properly choosing the media order and introduction point for the beneficial compounds. For example, many organic compounds are removed by activated carbon. If beneficial compounds are to be introduced, it is advantageous to introduce them after the activated carbon stage in the filter, preferably at the last stage so that there is no interference or uptake by the filter. The filter cartridge may be designed such that the proper order is maintained in a user configured system so that the potential for filter uptake of desirable compounds is eliminated. Cartridges may have tabs, protrusions, recesses, threads, or different diameters to ensure that the filter cartridge is loaded in the proper orientation and in the proper order. If a timed release system is implemented, its lifetime may be monitored by a timing, calendar, or active sensor device which can monitor the released compound or measures the amount or volume of water to alert the user to when it is depleted and needs changing. In some embodiments the filtration modules (such as disinfection module 801, arsenic module 802, and pathogen module 803) are permeable supplementation components such as flavor vitamins and pharmaceuticals whereby the supplementations are not substantially reduced when water passes through the filter and are maintained in the water at substantially the same quantity level after water passes through the entire filter as when introduced by the supplementation modules. In some embodiments, the supplementation modules may be positioned down stream of the filtration modules 801-803.

Instead of granular medias, foams or fibers impregnated with the above materials may be used for the representative stages.

In some embodiments, the modules for each stage may be provided in a form such that each module separate snaps into a magazine type holder to allow the user to perform some degree of customization of the filtration system. The base pathogen, taste improvement, and lead removal functionality may be base components of the system in some embodiments. The user may have the option of increasing the filtration capability for arsenic or fluoride or both depending on the local water conditions. In accordance with various inventive embodiments, a website with a zip code database may be utilized to assist with notifying a user of a recommended filter or cartridge modules for them based on local water reports. For example, in a region with excessive fluoride, the user could snap in two fluoride modules to extend the filter lifetime and provide added protection. These filter elements may be color coded to allow the user to easily differentiate between modules and functionalities. For example, the arsenic module could be red, while the fluoride module could be blue.

In such a magazine or snap embodiment, the snap in filter element are configured to eliminate filter bypass. In some embodiments, this may be accomplished by fabricating filter elements out of different materials, with the outer filter wall being a hydrophobic plastic or coating to help channel the water away from the filter edges towards the center. Such configurations help eliminate edge effects and improve filter performance. In some embodiments filter walls include a hydrophobic polymer coating, or use of a hydrophobic polymer for the filter sidewall. In another embodiment, the filter may be constructed from a teabag or paper type material. The outside edge (for example outer 1 cm) may be hydrophobic coating such as a wax. In these cases, the water is urged towards the center to minimize bypass.

In embodiments providing the multistage filtration modules in circular puck forms, o-ring seals may be implemented with locking cam groves to lock modules in place with a twisting motion as in electronic BNC connectors. Similarly, screw threads with o-rings or other approaches may be used to allow the user to assemble the filtration stack in a robust, leak tight configuration. In addition, threads or cams may be chosen so that the filtration stack is can be assembled in only a specific configuration and thus, different modules would have different screw or cam configurations. For example, the last module in the stack may be devoid of a thread or cam on its bottom side, such that when used it may only be integrated as the final stage in the multistage filtration module. The first mandatory module may be provided with the only thread or cam arrangement that mates to the filtration appliance, thereby requiring that a particular module such as the disinfection module or other filtration module be encountered first by fluids flowing through the multistage filtration module and further requiring all other modules to mate to this module. This approach would give the user a degree of supervised customization such that the filtration system is always assembled in the proper order for efficacy.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A water filtration apparatus comprising:
a filtration receptacle, the filtration receptacle having a water inlet and a water outlet, the filtration receptacle having a filter positioned therein, the filter disposed between the water inlet and the water outlet, the filter comprising a plurality of removable filtration modules selected from the group consisting of a disinfection module, a taste improvement module, an organic contaminant removal module, an arsenic removal module, a base pathogen module, a mineral removal module, a salt removal module, a flavor module, a vitamin module, and a pharmaceutical module, the filtration modules stackable in a specified order within the filtration receptacle by the user.

2. The apparatus of claim 1, wherein the disinfection module, the organic contaminant removal module, the arsenic removal module, the base pathogen removal module, the mineral removal module, and the salt removal modules are permeable to at least one flavor from the flavor module, at least one vitamin from the vitamin module, and at least one pharmaceutical from the pharmaceutical module.

3. The apparatus of claim 1, wherein the flavor module, vitamin module, and pharmaceutical module are downstream of one or more of the removable filtration modules, whereby water passing through the filter permeates one or more of the disinfection module, the organic contaminant removal module, the arsenic removal module, the base pathogen removal module, the mineral removal module, and the salt removal module before permeating one or more of the flavor, vitamin and pharmaceutical modules.

4. The apparatus of claim 1, where the filtration receptacle is coupled to a carafe, such that an interior region in the carafe is coupled to the water outlet in the filtration receptacle.

5. A disposable water filtration cartridge for use with a water filtration apparatus comprising:
a cartridge seal coupled to a cartridge housing, the cartridge housing having a geometric shape corresponding to a cartridge receptacle of the water filtration apparatus, the cartridge housing having an interior partitioned into a filtration region and a supplementation compartment;
a filtration substance disposed within filtration region; and
a supplementary substance disposed within the supplementation region compartment, wherein the filtration region is partitioned from the supplementation region such that liquids entering the filtration region traverse the filtration substance and subsequently enters the supplementation region traverses the filtration substance before exiting the cartridge.

6. The disposable water filtration cartridge of claim 5, wherein the filtration region and the supplementation region are disposed in a stacked orientation and the cartridge housing includes a solid partition wall having an opening positioned adjacent to a peripheral wall of the cartridge housing, the opening providing a fluid pathway between the filtration region and the supplementation region.

7. The disposable water filtration cartridge of claim 5, wherein the filtration region and the supplementation region are disposed in a lateral orientation and the cartridge housing includes a solid partition wall having an opening positioned at the top and periphery of both the filtration region and the supplementation region, the opening providing a fluid pathway between the filtration region and the supplementation region.

8. The disposable water filtration cartridge of claim 5, wherein the filtration region and the supplementation region are disposed in a stacked orientation and the filtration substance partitions the filtration region from the supplementation region.

9. The disposable water filtration cartridge of claim 5, wherein the filtration substance comprises an adsorption material selected from the following list: activated carbon, a metal oxide, or a metal hydroxide, whereby the filtration cartridge is operable to filter water in a temperature range of 5 C to 40 C.

10. The disposable water filtration cartridge of claim 5, wherein the filtration substance comprises an ion exchange resin or zeolite, whereby the filtration cartridge is operable to filter water in a temperature range of 5 C to 99 C.

11. The disposable water filtration cartridge of claim 5, wherein the filtration region and the supplementation region are separated by a water permeable layer, the water permeable layer providing a fluid pathway between the filtration region and the supplementation region across a substantial portion of its cross sectional area.

12-15. (canceled)

16. A water filtration apparatus comprising:
a base;
a filtration receptacle coupled to the base, the filtration receptacle having a water inlet and a water outlet, the filtration receptacle having a filter positioned therein, the filter disposed between the water inlet and the water outlet;
a carafe removably coupled to the base, such that a carafe inlet is coupled to the water outlet in the filtration receptacle; and
a supplementation receptacle coupled to the base, the supplementation receptacle configured for holding a supplementary substance therein, the supplementation receptacle further comprising a supplementation receptacle entry port in fluid communication with the water outlet in the filtration receptacle, the supplementation receptacle having a fluid path selectively coupled to a single serve outlet port disposed above a single serve holder region coupled to the base and a carafe entry port in the carafe, whereby the filtration apparatus may be operated to selectively filter and supplement a water based beverage for a single or a bulk serving.

17. The water filtration apparatus of claim 16, wherein
the filter comprises a plurality of removable filter modules selected from the group consisting of a disinfection module, a taste improvement module, an organic contaminant removal module, an arsenic removal module, a base pathogen module, a mineral removal module, a salt removal module, a flavor module, a vitamin module, a pharmaceutical module which are user configurable.

18. The water filtration apparatus of claim 17, further comprising a plurality of erosion based filter module status indicators, each indicator in the plurality of indicators corresponding to a specific filter module in the plurality of removable filter modules, the plurality of indicators positioned between the water inlet and the water outlet, each indicator in the plurality of indicators providing a signal representative of the status of the corresponding filter module, the signal provided after a predetermined amount of flow dependent erosion from the respective indicator.

19. The water filtration apparatus of claim 16, further comprising an erosion based filter status indicator, the indicator positioned between the water inlet and the water outlet, the indicator providing a signal indicating a status of the filter, the signal provided after a predetermined amount of flow dependent erosion has occurred to the indicator.

20. (canceled)

21. The water filtration apparatus of claim 19, wherein the signal is electronic.

22. The water filtration apparatus of claim 19, wherein the signal is at least one of a visual indicator, an audible indicator, and a taste indicator.

23. The water filtration apparatus of claim 19, wherein the signal is a visual indicator configured to change color.

24. The water filtration apparatus of claim 19, wherein the signal is a visual indicator including a word.

25-32. (canceled)

33. The water filtration apparatus of claim 19 wherein the indicator is based on a water quality parameter selected from the following list: temperature, TDS, pH, mineral content.

34-63. (canceled)
